(19) United States
(12) Patent Application Publication
(10) Pub. No.: US 2006/0076829 A1
(43) Pub. Date: Apr. 13, 2006

(54) Vehicle brake system equipped with a friction brake and a regenerative brake

(76) Inventors: Karsten Mann, Stuttgart (DE); Uwe Bauer, Schwieberdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/214,953

(22) Filed: Aug. 31, 2005

(30) Foreign Application Priority Data
Aug. 31, 2004 (DE) 10 2004 042 028.9

(51) Int. Cl. B60T 8/64

(52) U.S. Cl. 303/151; 303/152; 303/155

(57) ABSTRACT

A vehicle brake system having at least one friction brake which a brake pedal and master cylinder are able to actuate, and having a regenerative brake, includes a compensation unit for manipulating the mechanical coupling between the brake pedal and the master cylinder during an operation of the regenerative brake.

### CROSS-REFERENCE TO RELATED APPLICATIONS

This application is based on German Patent Application 10 2004 042 028.9 filed Aug. 31, 2004, upon which priority is claimed.

### BACKGROUND OF THE INVENTION

1. Field of the Invention

The present invention relates to an improved vehicle brake system and more particularly to such a brake system equipped with at least one friction brake, which can be actuated by means of a brake pedal and a master cylinder, and equipped with a regenerative brake.

2. Description of the Prior Art

In modern vehicles, it is known to provide the wheels with friction brakes that a driver of the vehicle can apply by means of a brake pedal and a consequently actuated master cylinder as well as a control unit that is, as a rule, hydraulic. In addition to such hydraulic friction brake systems, in hybrid electric vehicles (HEV), the wheels are braked electromagnetically, with the braking energy being converted into electrical energy and then stored (regeneration).

In order to permit such an operation of a regenerative brake, the driver's desire to brake is detected at the brake pedal actually provided for the friction brakes and the associated friction brake system. Then, at least a portion of the braking force that would usually be applied by the friction brake system is exerted by an electric motor.

The integration of a regenerative brake into hydraulic vehicle brake systems requires making design changes to the brake hydraulics and their control. For example, it requires development of new control algorithms for associated hydraulic valves, implementation of sensors for pressure and distance detection, and adaptation of a large number of components to new requirements.

DE 195 24 228 A1 has disclosed a vehicle brake system with a regenerative brake in which on the one hand, there must always be a fixed relationship between the pedal path and the braking action and on the other hand, it must be possible to reliably compensate for the occurrence of a malfunction in the regenerative brake. To this end, a continuous mechanical/hydraulic connection is produced between a brake pedal and the wheel brake cylinders. The action of the brake application with the regenerative brake in response to the actuation of the brake pedal is compensated for in that a control unit with valves can reduce the pressure in the wheel brake cylinders in relation to the pressure in the master cylinder.

OBJECT AND SUMMARY OF THE INVENTION

The object of the present invention is to produce a vehicle brake system of the type mentioned above in which the integration of the regenerative brake into the brake hydraulics is particularly simple to develop and manufacture.

The object is attained according to the invention with a vehicle brake system of the species-defining type in which a compensation device is provided for manipulating a mechanical coupling between the brake pedal and the master cylinder during operation of the regenerative brake.

According to the present invention, during operation of a regenerative brake in a vehicle brake system, the mechanical action of the brake pedal on the master cylinder is manipulated. The manipulation according to the present invention changes the mechanical coupling of the brake pedal to the master cylinder present in known vehicle brake systems and gives the brake pedal the pedal feel familiar to the driver from conventional systems. The manipulation of the mechanical coupling can be embodied for a more reasonable price than the alterations required in known vehicle brake systems in order to change the control algorithms and other components of the brake hydraulics. In particular, the systems according to the present invention require comparatively little development outlay. Moreover, the embodiment according to the present invention can be used to alter a vehicle brake system merely by replacing the braking desire detection unit with a regenerative function. The actual brake system (hydraulic unit and friction brakes) can remain unchanged.

In an advantageous modification of the vehicle brake system according to the present invention, a brake force booster is situated between the brake pedal and the master cylinder and the compensation unit is provided between the brake force booster and the brake pedal. With a compensation unit of this kind, it is possible to adopt the entire arrangement and in particular, the fastening, from known brake force boosters. In an alternative modification of the vehicle brake system according to the present invention, the compensation unit is provided between the master cylinder and the main brake force booster. In a system of this kind, for example, the entire brake force booster is moved as well, but the units comprising the brake force booster and brake pedal can be adopted from known systems.

The compensation unit according to the present invention should also be embodied with an actuation travel decoupling unit that changes the actuation travel of the brake pedal. When such an actuation travel decoupling unit is provided, then in a regenerative braking situation, i.e. when a braking action is exerted by an electric motor of the drive train, the actuation travel decoupling unit compensates for the movement of the brake pedal initiated by the driver. For example, the path of the brake pedal is adapted in such a way that the master cylinder is not displaced.

For safety reasons, vehicle brake systems should have a mechanical connection between the brake pedal and the master cylinder during their entire operation, i.e. even during regenerative braking operation. In order to assure this, the actuation travel decoupling unit according to the present invention can be equipped with a cam. With a rotation of the cam, the actuation travel of the brake pedal, for example, is moved in a manner, which, to the driver, seems equivalent to conventional systems. If the regenerative brake fails, then the pedal actuation by the driver immediately acts on the released master cylinder by means of the rotated cam.

The compensation unit according to the present invention should simulate not only the actuation travel of conventional brake pedals, but also its overall dynamic behavior. To that end, an actuation force decoupling unit should be provided, which offers the driver the same resistance as conventional vehicle brake systems.

Such functions can be achieved in a particularly advantageous manner, for example, with a mechatronic actuator. In a manner similar to active vehicle steering systems, the actuator can be embodied with a gear unit that engages the mechanical system of levers or gears or, in a particularly inexpensive design, can be embodied with a cylinder/piston unit. In general, the compensation unit according to the present invention can be used with an extremely wide variety of actuators for path and angle adjustments.

Particularly inexpensive designs are possible by redesigning a vehicle brake system with a brake force booster in such a way that the pressure difference in the brake force booster can be regulated with a pump, for example, and/or a valve (in particular an air inlet valve).

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 shows a very schematic, partially sectional side view of a known vehicle brake system,

FIG. 2 shows a partially sectional side view of a subassembly comprising brake pedal, brake force booster, and master cylinder, according to a first exemplary embodiment of the present invention,

FIG. 3 shows the view from FIG. 2 of a second exemplary embodiment of the present invention,

FIG. 4 shows the view from FIG. 2 of a third exemplary embodiment of the present invention in a first position,

FIG. 5 shows the view from FIG. 4 in a second position,

FIG. 6 shows the view from FIG. 2 of a fourth exemplary embodiment of the present invention in a first position, and

FIG. 7 shows the view from FIG. 6 in a second position.

### DESCRIPTION OF THE PREFERRED EMBODIMENTS

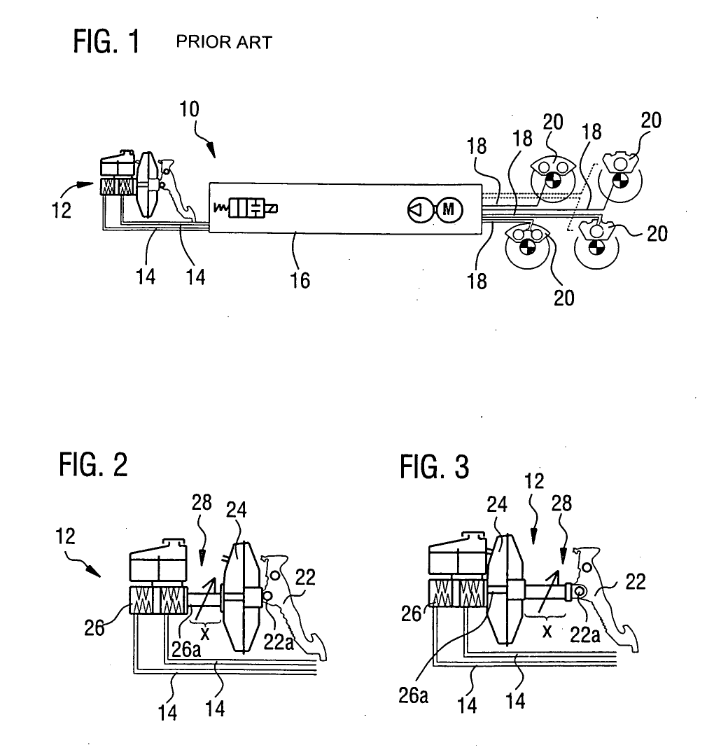

FIG. 1 shows a vehicle brake system 10 of which one of the essential components is shown in the form of a subassembly 12 that includes a brake pedal, a brake force booster, and a master cylinder. The subassembly 12 is connected via two lines 14 to a hydraulic control unit 16 that contains hydraulic valves and pump elements that are not shown. The hydraulic control unit 16 is connected via lines 18 to a total of four friction brakes 20.

The vehicle brake system 10 is provided with an electrical drive unit, also not shown, that can also brake the wheels associated with the friction brakes 20 in the context of a regenerative function.

FIGS. 2 to 7 show different embodiment forms of the subassembly 12 with a brake pedal 22 attached to it, a brake force booster 24, and a master cylinder 26. They will be explained in greater detail further below.

In a regenerative braking situation, in order to give a driver a pedal feel at the brake pedal 22 that corresponds to that of a conventional vehicle brake system, each subassembly 12 is provided with a compensation unit 28. This compensation unit 28 serves to manipulate or decouple a mechanical coupling that is always present between the brake pedal 22 and the master cylinder 26.

As is clear from FIGS. 2 and 3, the compensation unit 28 serves in particular to adjust the pedal path of the brake pedal 22. This adjustment occurs either essentially between the brake force booster 24 and the master cylinder 26, as depicted in FIG. 2, or essentially between the brake pedal 22 and the brake force booster 24, as depicted in FIG. 3. In the adjustment of the pedal path, in particular a change is made to a path X between a piston rod 26a of the master cylinder 26 and a pivot bearing 22a of the brake pedal 22. The brake force booster 24 situated between the piston rod 26a and the pivot bearing 22a can remain essentially unchanged.

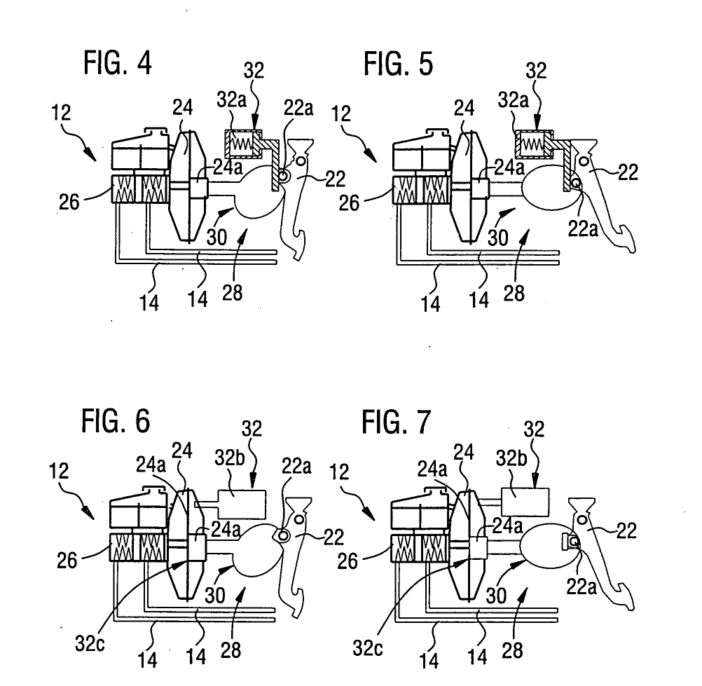

FIGS. 4 to 7 show exemplary embodiments of compensation units 28 that are essentially situated between the brake pedal 22 and the brake force booster 24.

The compensation units 28 each have an actuation travel decoupling unit 30 and an actuation force decoupling unit 32. These devices, which manipulate the actuation travel and actuation force at the brake pedal 22 during a regenerative braking maneuver, replicate in particular the dynamics and behavior of a conventional brake pedal.

In both the exemplary embodiment according to FIGS. 4 and 5 and the exemplary embodiment according to FIGS. 6 and 7, the actuation travel decoupling unit 30 is embodied with a cam that always assures a mechanical connection between the pivot bearing 22a and a central element 24a of the brake force booster. Particularly in the event of a temporary failure of the regenerative brake, the cam assures a pressure-resistant connection so that the brake pedal 22 can then act in the usual way on the brake force booster 24 and the master cylinder 26 and the associated vehicle can still be reliably braked.

In the exemplary embodiment according to FIGS. 4 and 5, the actuation travel decoupling unit 32 is equipped with an actuator that has a cylinder/piston unit 32a and engages the pivot bearing 22a, in particular directly.

In the exemplary embodiment according to FIGS. 6 and 7, the actuation force decoupling unit 32 is equipped with both a vacuum pump 32b and an air inlet valve or ventilation valve 32c that are situated on the brake force booster and can change the pressure ratios therein that act on a diaphragm 24b of the brake force booster 24.

The foregoing relates to preferred exemplary embodiments of the invention, it being understood that other variants and embodiments thereof are possible within the spirit and scope of the invention, the latter being defined by the appended claims.

We claim:

1. A vehicle brake system (10) comprising
at least one friction brake (20), which a brake pedal (22) and master cylinder (26) are able to actuate,
a regenerative brake, and
a compensation unit (28) for manipulating a mechanical coupling between the brake pedal (22) and the master cylinder (26) during an operation of the regenerative brake.

2. The vehicle brake system according to claim 1, further comprising a brake force booster (24) situated between the brake pedal (22) and the master cylinder (26), the compensation unit (28) being provided between the brake force booster (24) and the brake pedal (22).

3. The vehicle brake system according to claim 1, wherein the compensation unit (28) comprises an actuation travel decoupling unit (30) that changes the actuation travel of the brake pedal (22).

4. The vehicle brake system according to claim 2, wherein the compensation unit (28) comprises an actuation travel decoupling unit (30) that changes the actuation travel of the brake pedal (22).

5. The vehicle brake system according to claim 3, wherein the actuation travel decoupling unit (30) comprises a cam.

6. The vehicle brake system according to claim 4, wherein the actuation travel decoupling unit (30) comprises a cam.

7. The vehicle brake system according to claim 1, wherein the compensation unit (28) comprises with an actuation force decoupling unit (32) that changes the actuation force of the brake pedal (22).

8. The vehicle brake system according to claim 2, wherein the compensation unit (28) comprises with an actuation force decoupling unit (32) that changes the actuation force of the brake pedal (22).

9. The vehicle brake system according to claim 3, wherein the compensation unit (28) comprises with an actuation force decoupling unit (32) that changes the actuation force of the brake pedal (22).

10. The vehicle brake system according to claim 4, wherein the compensation unit (28) comprises with an actuation force decoupling unit (32) that changes the actuation force of the brake pedal (22).

11. The vehicle brake system according to claim 5, wherein the compensation unit (28) comprises with an actuation force decoupling unit (32) that changes the actuation force of the brake pedal (22).

12. The vehicle brake system according to claim 6, wherein the compensation unit (28) comprises with an actuation force decoupling unit (32) that changes the actuation force of the brake pedal (22).

13. The vehicle brake system according to claim 7, wherein the actuation force decoupling unit (32) comprises an actuator that acts on the brake pedal (22).

14. The vehicle brake system according to claim 8, wherein the actuation force decoupling unit (32) comprises an actuator that acts on the brake pedal (22).

15. The vehicle brake system according to claim 13, wherein the actuator comprises with a cylinder/piston unit (32a) that is, in particular, hydraulic.

16. The vehicle brake system according to claim 14, wherein the actuator comprises with a cylinder/piston unit (32a) that is, in particular, hydraulic.

17. The vehicle brake system according to claim 5, further comprising a brake force booster (24), and wherein and the actuation force decoupling unit (32) comprises with a pump (32b) that acts on the brake force booster (24) and/or a valve (32c) that acts on the brake force booster (24).

18. The vehicle brake system according to claim 6, further comprising a brake force booster (24), and wherein and the actuation force decoupling unit (32) comprises with a pump (32b) that acts on the brake force booster (24) and/or a valve (32c) that acts on the brake force booster (24).

19. The vehicle brake system according to claim 7, further comprising a brake force booster (24), and wherein and the actuation force decoupling unit (32) comprises with a pump (32b) that acts on the brake force booster (24) and/or a valve (32c) that acts on the brake force booster (24).

20. The vehicle brake system according to claim 8, further comprising a brake force booster (24), and wherein and the actuation force decoupling unit (32) comprises with a pump (32b) that acts on the brake force booster (24) and/or a valve (32c) that acts on the brake force booster (24).
